(19) United States
(12) Patent Application Publication
(10) Pub. No.: US 2023/0240465 A1
(43) Pub. Date: Aug. 3, 2023

(54) Syringe Type Manual Pressure Brewing Device

(71) Applicant: Newking Limited, New Territories (HK)

(72) Inventor: Fung Pui Yan, New Territories (HK)

(21) Appl. No.: 18/102,370

(22) Filed: Jan. 27, 2023

(30) Foreign Application Priority Data
Jan. 28, 2022 (HK) 32022047275.9

(51) Int. Cl. A47J 31/02; A47J 31/06; A47J 31/40; A47J 31/36

(52) U.S. Cl. CPC A47J 31/02; A47J 31/06; A47J 31/40; A47J 31/36; A47J 31/20

(57) ABSTRACT

A syringe-type manual pressure brewing device is disclosed. It includes an accommodating bin for accommodating coffee powder. A syringe barrel is installed above the accommodating bin. A pushing rod and a piston thereof airtightly fitted to the syringe barrel are installed inside the syringe barrel. The piston is installed below the pushing rod for manually operating pressure extraction on coffee or tea along the syringe barrel. A pressure valve is further installed between the syringe barrel and the accommodating bin for increasing the pressure in the syringe barrel. At least one check valve is installed on a bottom of the accommodating bin for controlling extraction concentration of coffee or tea. The syringe-type manual pressure brewing device includes the structure of the syringe barrel and pushing rod with matched pressure valve, and the check valve controls different extraction pressure to achieve a choice of different coffee or tea strength and taste.

### FIELD OF THE INVENTION

The present invention relates to a pressure brewing device. More particularly, the present invention relates to an improvement of a syringe-type manual pressure brewing device.

### BACKGROUND OF THE INVENTION

Coffee machines in the prior art usually adopt automatically controlled extraction process, e.g., coffee/tea beverage extraction by spraying hot water at a predetermined temperature, or immersion extraction. However, in actual use, manual pressure brewing devices use water of any temperature under pressure. Especially in portable or outdoor use scenarios and requirements, manual pressure extraction is also a product requirement that needs to be designed and improved, in order to be able to realize the extraction of coffee/tea beverages in more cases. However, in the prior art, there is no device that is convenient for pressing to brew and extract.

There are already some devices for manually extracting coffee in the prior art. For example, China patent CN 206565784 U and CN 208799069 U have disclosed portable or manual pressing coffee extraction devices with a pushing rod. However, their structural designs only provide manual pressing structures, but pressure driving methods are single. They cannot cope with the pressure extraction needs of consumers for different coffees.

Therefore, prior art still needs to be improved and developed.

### SUMMARY OF THE INVENTION

The purpose of the present invention is to provide a syringe-type manual pressure brewing device. A convenient manual pressing device for brewing and extracting is provided to address the above-mentioned shortcomings of the prior art. It can meet the requirements of consumers in the market for regulating different extraction pressures to obtain different flavors of coffee or tea beverage by manual extraction. Its small size makes it easy to carry and use.

The technical solution of the present invention is as follows.

A syringe-type manual pressure brewing device comprises an accommodating bin for accommodating coffee powder or tea leaves. A syringe barrel is installed above the accommodating bin. A pushing rod and a piston thereof airtightly fitted to the syringe barrel are installed inside the syringe barrel. The piston is installed below the pushing rod for manually operating pressure brewing extraction along the syringe barrel. A pressure valve is installed between the syringe barrel and the accommodating bin for increasing the pressure in the syringe barrel. At least one check valve is installed on a bottom of the accommodating bin for controlling extraction concentration of coffee or tea beverages. The check valve includes corresponding mounting holes on a mounting plate on a bottom of the accommodating bin; a base tube installed in each mounting hole; a silicone cap assembled on the lower side of the base tube; and a cut formed on the silicone cap.

For the syringe-type manual pressure brewing device, a control panel is further installed on the outside of the mounting plate, an opening corresponding to the position of the check valve is formed on the control panel, and the control panel is rotated to adjust corresponding degree of openness between the opening and the check valve.

For the syringe-type manual pressure brewing device, the pressure valve is made of a silicone orifice plate, and the cut which is able to close naturally is formed on each silicone hole on the silicone orifice plate.

For the syringe-type manual pressure brewing device, the cut is a cross cut, a straight line cut or a double cross cut, the cut is formed on a protruded portion inside the silicone hole, and the protruded portion is installed to face the accommodating bin.

For the syringe-type manual pressure brewing device, a top of the pushing rod has a pushing rod head for conveniently pressing.

For the syringe-type manual pressure brewing device, a container cup is mounted below the control panel, and a blocking portion which is extensionally installed around the outer edge of the accommodating bin is used to position the container cup.

For the syringe-type manual pressure brewing device, the bottom of the accommodating bin further has a metal filter for blocking the coffee powder or tea leaves.

For the syringe-type manual pressure brewing device, a sealing ring is installed around the outer edge of the piston for hermetically contacting an inner wall of the syringe barrel.

Since the syringe-type manual pressure brewing device provided by the present invention adopts the structure of the syringe barrel and pushing rod with matched pressure valve. It provides enough pressure to quickly extract coffee or tea. Meanwhile, different extraction pressures are controlled by the check valve to achieve a choice of different coffee or tea strength and taste. Therefore, a portable and practical syringe-typed manual pressure brewing device is provided.

### BRIEF DESCRIPTION OF THE DRAWINGS

FIG. 1 is an exploded and partially sectional schematic diagram of a preferred embodiment of the syringe-type manual pressure brewing device of the present invention;

FIG. 2 is a sectional view of the preferred embodiment of the syringe-type manual pressure brewing device of the present invention;

FIG. 3 is a top view of the pressure valve plate of the preferred embodiment of the syringe-type manual pressure brewing device of the present invention;

FIG. 4 is a bottom view of the pressure valve plate of the preferred embodiment of the syringe-type manual pressure brewing device of the present invention;

FIG. 5 is a sectional view of the pressure valve plate along an A-A direction in FIG. 3;

FIG. 6 is a top perspective view of the pressure valve plate;

FIG. 7 is a bottom perspective of the pressure valve plate;

FIG. 8 is a top view of a check valve silicone cap in the preferred embodiment of the syringe-type manual pressure brewing device of the present invention;

FIG. 9 is a sectional view of the check valve silicone cap along a B-B direction in FIG. 8;

FIG. 10 is a top perspective view of the check valve silicone cap;

FIG. 11 is a bottom perspective view of the check valve silicone cap;

FIG. 12 is a top view of a base tube in the preferred embodiment of the syringe-type manual pressure brewing device of the present invention;

FIG. 13 is a sectional view of the base tube along an AA-AA direction in FIG. 12;

FIG. 14 is a sectional view of the base tube along a BB-BB direction in FIG. 12;

FIG. 15 is a top perspective view of the base tube; and

FIG. 16 is a bottom perspective view of the base tube.

### DETAILED DESCRIPTION OF THE PREFERRED EMBODIMENTS

A preferred embodiment of the present invention is described in detail below.

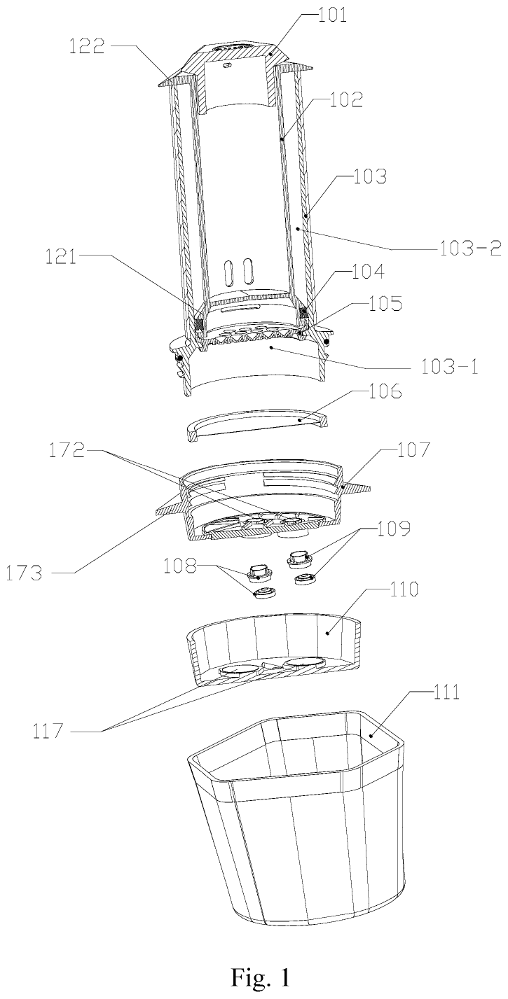

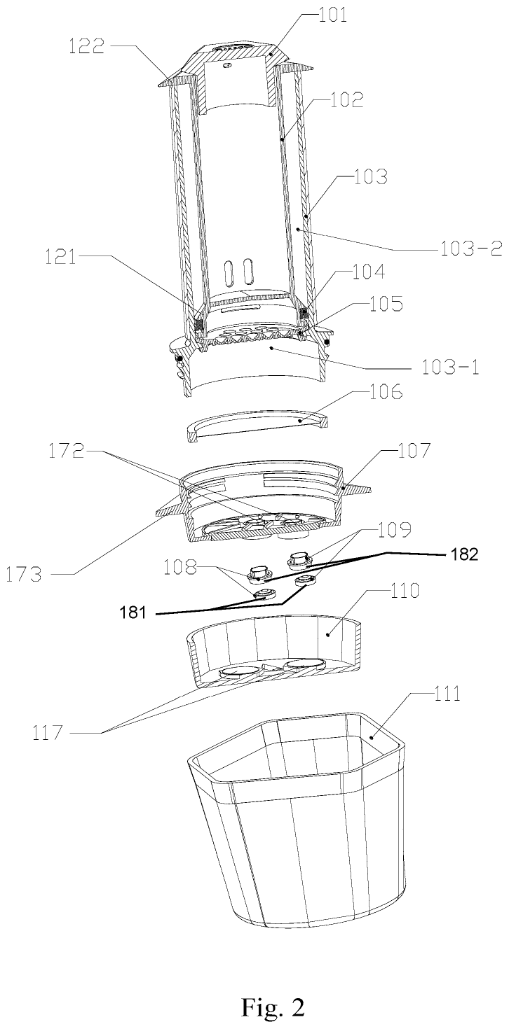

The preferred embodiment of the syringe-type manual pressure brewing device is provided by the present invention, as shown in FIG. 1 and FIG. 2. It comprises an accommodating bin 103-1 for accommodating coffee powder or tea leaves 200. The accommodating bin 103-1 is specifically formed by extending downward from a pot body 103 and enlarging the inner diameter. The structure below the accommodating bin generally consists of a lower cover 107 which can be assembled with the lower part of the pot body 103 by formed threads, with the accommodating bin 103-1 formed therein.

A syringe barrel 103-2 is installed above the accommodating bin, having a cylindrical cavity structure with upper and lower parts directly connected with the accommodating bin 103-1. A pushing rod 102 and its piston 121 appropriately and airtightly fitted to an inner wall of the syringe barrel 103-2 are installed inside the syringe barrel 103-2. The piston 121 is installed below the pushing rod 102. Through the tight fit between the piston 121 and the interior of the syringe barrel 103-2, downward manual pressure is created to cause coffee or tea to be extracted. A sealing ring 104 and its mounting slot are installed around the outer edge of the piston 121 to ensure the piston 121 hermetically contacts the inner wall of the syringe barrel 103-2.

A pushing rod head 101 is installed on the top of the pushing rod 102. The pushing rod head 101 and the pushing rod 102 can be integrated or can be easily assembled. The pushing rod head 101 has a flat top surface on an upward side and larger area to facilitate the force when pressing down with the hand. The pushing rod 102 can also be processed with pipe profiles. The outer periphery of the upper end of the pushing rod 102 is provided with an outer skirt 122, as shown in FIG. 2, to prevent the pushing rod 102 from falling too deeply into the syringe barrel 103-2 during manual coffee press operation to affect the next operation.

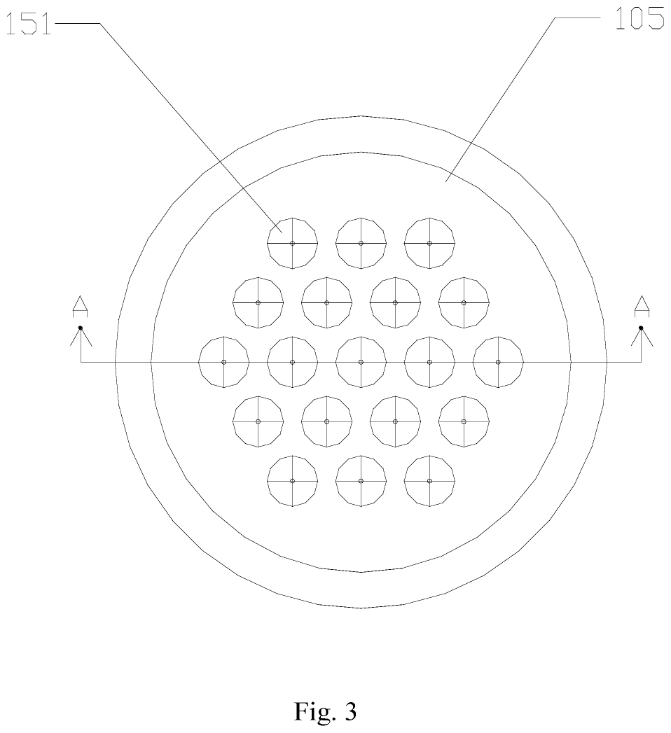

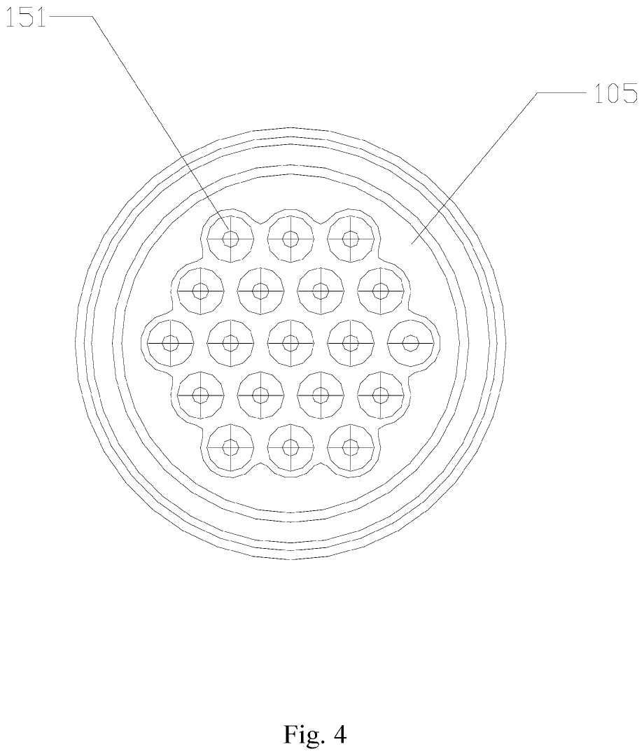

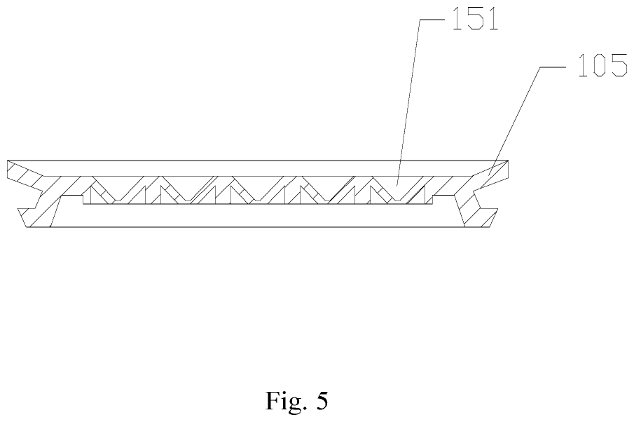

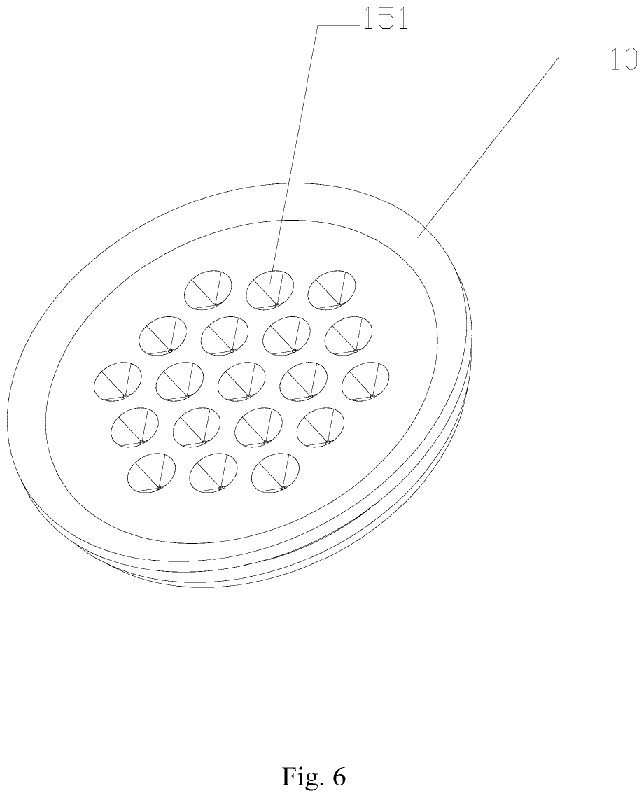

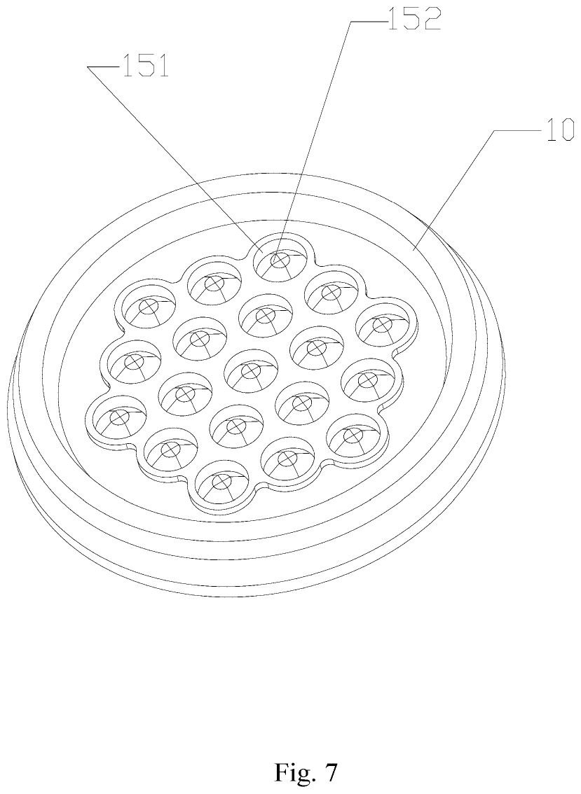

Between the syringe barrel 103-2 and the accommodating bin 103-1, in the preferred embodiment of the syringe-type manual pressure brewing device of the present invention, a pressure valve 105 is installed for passively increasing the pressure in the syringe barrel 103-2. As shown in FIG. 3 to FIG. 7, the pressure valve 105 is made of a silicone orifice plate. A number of silicone holes 151 are formed on it, specifically but not limited to various distribution methods. As shown in the figure, there are 19 silicone holes distributed in a regular hexagon. In each silicone hole 151 structure, a protruded portion 152 is formed and concave on one side and convex on the other, i.e., the side facing the accommodating bin 103-1 and the coffee powder or tea leaves, as shown in FIG. 7, a pre-cut cut is formed on the top of the protruded portion 152. The cut is a cross cut, a straight line cut or a double cross cut and other forms of cut. The cut is closed in the natural state, and when the hand presses the pushing rod 102 down to squeeze the coffee, the cut can only be opened after the hot water in the syringe barrel 103-2 has a certain pressure through the pre-closed obstruction, so as to create a pressure-enhanced water flow that rushes into the coffee powder or tea leaves below.

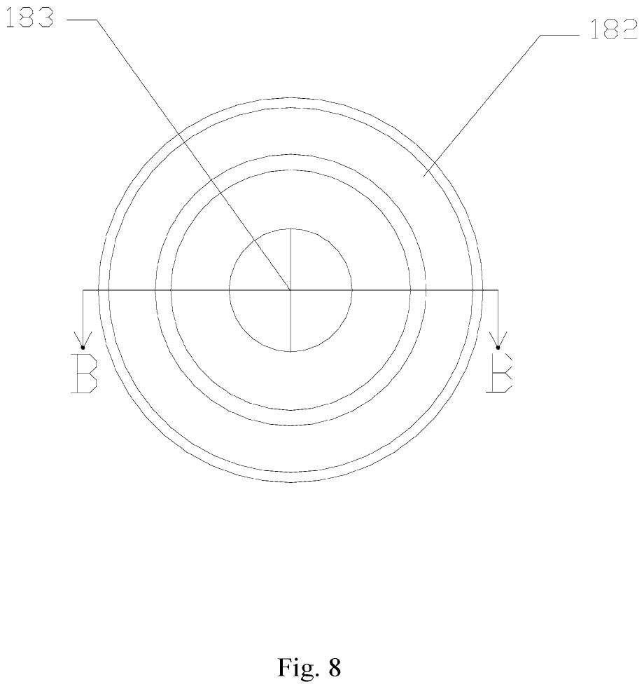

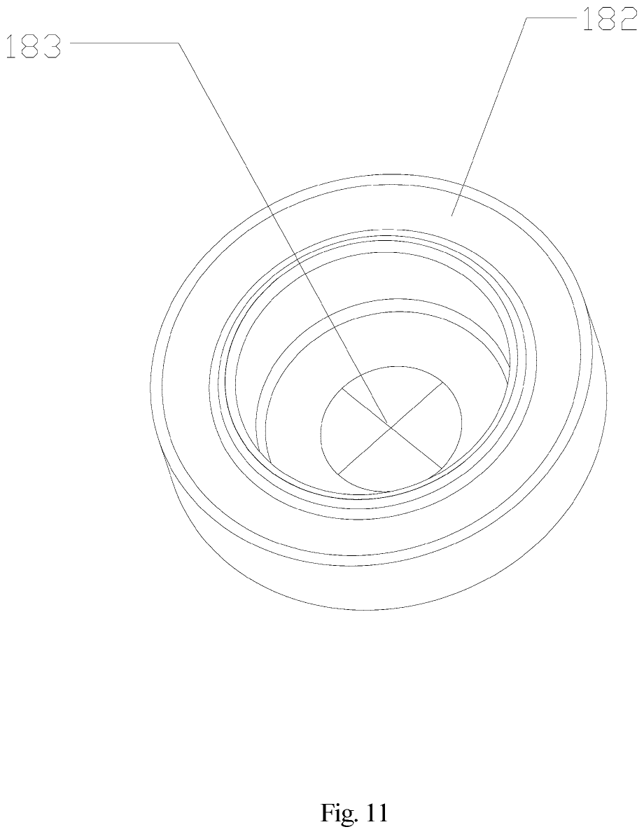

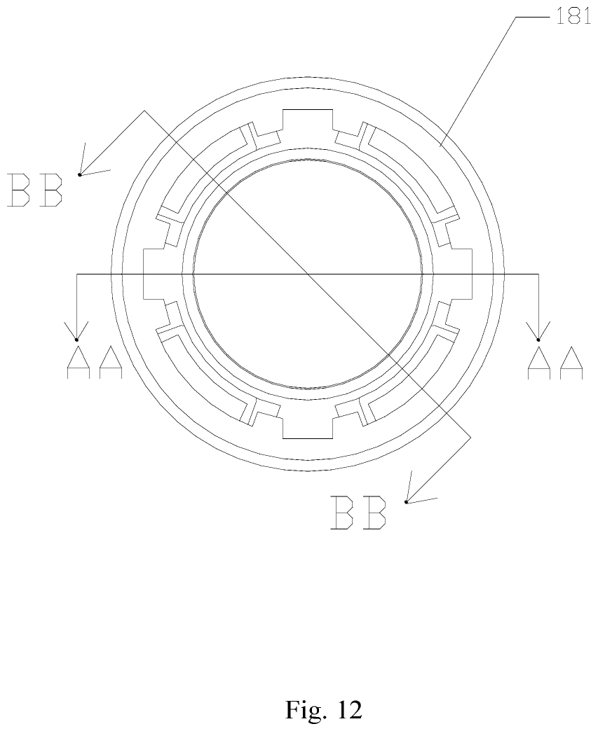

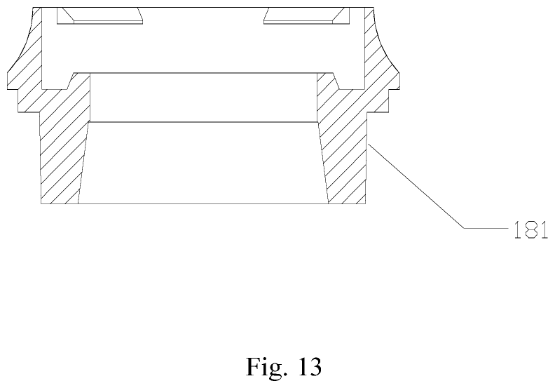

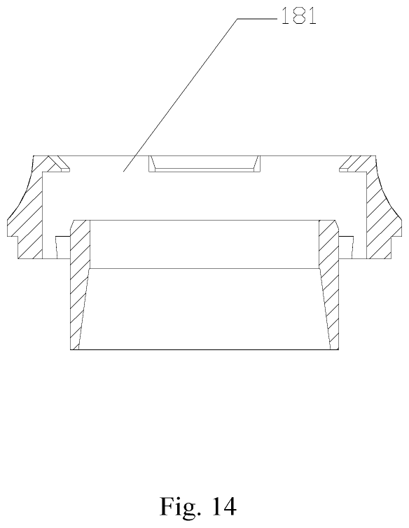

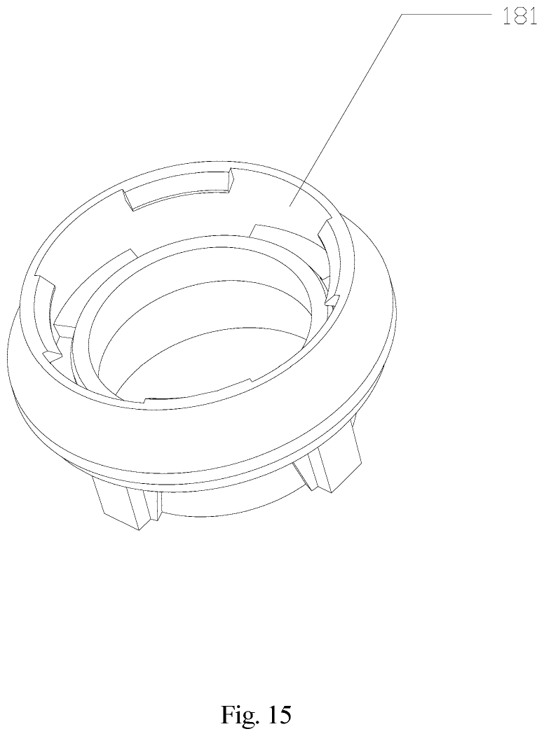

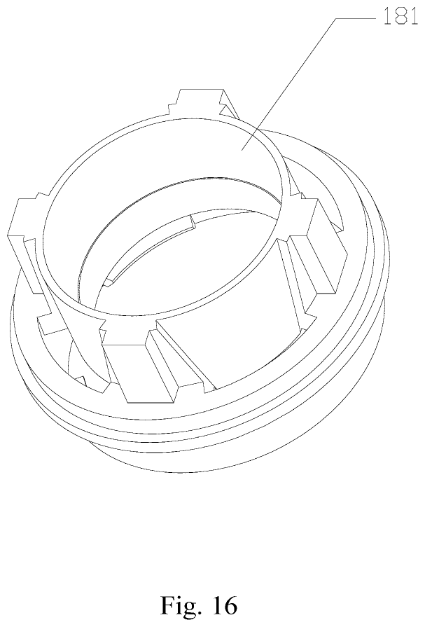

In the accommodating bin 103-1 of the preferred embodiment of the syringe-type manual pressure brewing device of the present invention, at least one check valve 108/109 is installed on the lower cover 107 on the bottom, as shown in FIG. 1 and FIG. 8 to FIG. 16. There are two check valves 108/109 in the preferred embodiment. In the case of more control methods, three or more check valves can also be set.

On the upper side of the lower cover 107, close to the bottom of the coffee powder or tea leaves 200, as shown in FIG. 2, there is a metal filter 106. A finer filter or a filter of other materials may be used. It prevents excessive coffee powder or tea leaves from falling into the container cup downstream, to improve the quality of extracted coffee or tea.

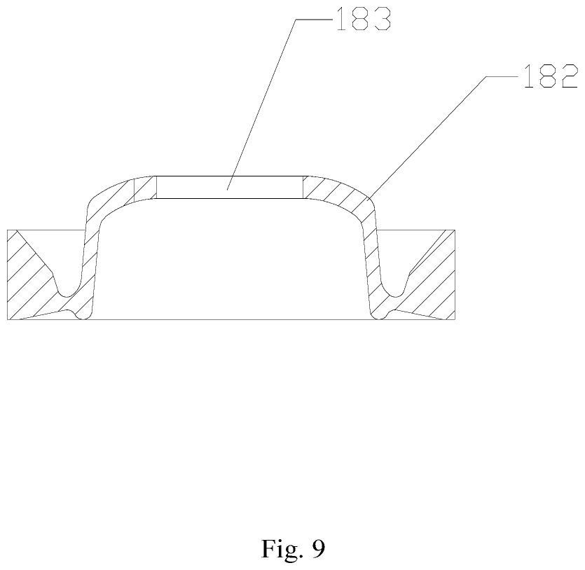

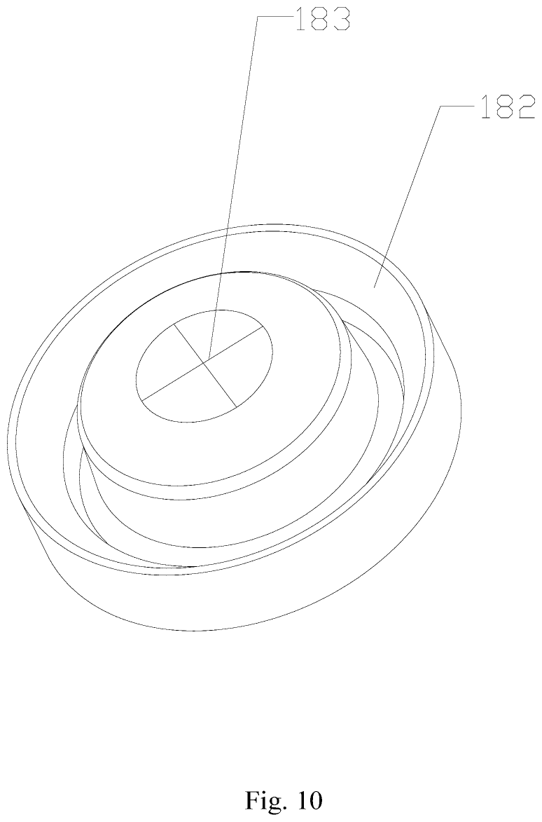

Each check valve 108/109 includes a silicone cap 182 and a base tube 181 to secure the silicone cap 182 in a respective mounting hole 172. A corresponding number of mounting holes 172 are formed on the bottom mounting plate of the lower cover 107, as the two of the examples in FIG. 1. The check valve 108/109 adopts the structure assembled to the base tube 181 in the mounting hole 172 where a silicone cap 182 assembled on the lower side of the base tube 181. A cut 183 is formed on the silicone cap 182. The cut 183 maintains a light natural closure. This can further form a pressure barrier when manually pressing the pushing rod 102 for better coffee extraction. In the structure of the silicone cap 182, the cut 183 is arranged in an upward concave-convex configuration, as shown in FIG. 1, FIG. 9 and FIG. 10. In this way, a one-way downward valve structure can be formed, so that coffee or tea can be extracted smoothly under pressure.

The upper side of the base tube 181 is thicker, and it is convenient to assemble into the mounting holes 172. The lower end of the base tube 181 is slightly thinner to form a neck, which is convenient for fixed connection and assembly with a groove on one side of the silicone cap 182.

A control panel 110 is installed on the outside of the mounting plate, covering and being installed on the lower outside of the lower cover 107. The control panel 110 also has openings 117 corresponding to the position of the check valve 108/109, as shown in FIG. 1. By rotating the control panel 110, it is possible to adjust corresponding degree of openness between the opening 117 and the check valve 108/109, so as to realize the control of concentration and flow coffee or tea.

Further, a container cup 111 is mounted below the control panel 110 for receiving the extracted liquid of coffee or tea. A blocking portion 173 is extensionally installed around the outer edge of the lower cover 107 of the accommodating bin. The blocking portion 173 is used to fittingly place on and block the cup mouth of the container cup 111. Thus, a portable manual pressure brewing and extraction device can be formed.

The present invention provides a preferred embodiment of a new kind of syringe-type manual pressure brewing extraction device. Through the pushing rod head 101, the pushing rod 102 and the piston 121 included in partial structure of a syringe-type pressure pot pushing rod, coffee powder is added to the cavity of the accommodating bin 103-1 of the pressure pot body, and hot water is added to the cavity of the syringe barrel 103-2 of the pressure pot body (hot water is added between the piston 121 and the pressure valve plate, and the piston 121 is used to press the hot water into the accommodating bin 103-1). After soaking for a certain period of time, coffee or tea extraction is carried out by pushing the pushing rod 102.

Through the pressure valve 105, the pressure in the cavity is increased. Water pressure is thus formed for the brewing operation of coffee or tea during the extraction process to increase open and close control of the check valve anti-leakage device 108/109 and control panel 110 as well as the metal filter 106 is enabled. Extraction pressure in the pressure pot is increased. Thus, the extraction of coffee or tea is more uniform, and the essence of coffee or tea can be better extracted to achieve the best taste. Meanwhile, the check valve anti-leakage device 108/109 and the control panel 110 also improve the problem of a secondary cleaning for the coffee or tea drips when the user moves the entire pressure pot.

In order to make the taste of the extracted coffee or tea obtained by the device in the preferred embodiment of the present invention suitable for more people, the syringe-type hand pressure pot chooses to open the pressurized leak-proof device 108 or 109 by rotating a certain angle and its common opening etc. based on the control of the control panel 110. This allows users to choose the strength and taste of the extraction according to their personal taste. Number of options is not limited to 2 extraction options. The designer can design more than 2 extraction methods according to the requirement, and pre-set prompt marks of the openings and positionings of the corresponding hand feeling, so as to facilitate the user's adjustment and selection. For some extreme enthusiasts, it is also possible to set the product type that does not provide the above-mentioned marks or the positionings of the hand feeling, in order to allow consumers to use and explore the preferred embodiment of the present invention for a long time, and gradually gain their own intuition through the manipulation experience of the control panel, so as to get the coffee or tea taste they want.

For the syringe-type manual pressure brewing device of the preferred embodiment of the present invention, after assembling the entire French pressure pot device, remove the pushing rod part first, rotate the control panel 110 for concentration selection, select pressurized leak-proof device 108 and/or 109 according to personal taste (if there are only two selection modes, but not limited to this), add coffee powder or tea leaves to the cavity of the accommodating bin 103-1 of the pressure pot, and inject hot or cold water into the syringe barrel 103-2 cavity of the pressure pot. Then, fit the pushing rod 102 into the syringe barrel 103-2. After soaking for a certain period of time, by pushing the pushing rod head 101, the pushing rod 102 moves downward. The air pressure in the cavity of the syringe barrel 103-2 of the pressure pot increases. The coffee solution passes through the silicone holes 151 of the pressure valve 105 to generate water pressure to brew coffee or tea in the cavity of the accommodating bin 103-1 of the press pot. The solution then passes through the second layer of metal filter 106 and the third layer of the check valve leak-proof device 108/109 to extract coffee or tea and drip it into the container cup 111. If the pushing rod head 101 is stopped, the check valve leak-proof device 108/109 on the third layer will be automatically closed to stop the dripping of coffee or tea and prevent leakage.

It should be understood that those skilled in the art may make improvements or transformations based on the above description, and all such improvements and transformations shall fall within the scope of protection of the appended claims of the present invention.

What is claimed is:

1. A syringe-type manual pressure brewing device, comprising an accommodating bin for accommodating coffee powder or tea leaves, wherein a syringe barrel is installed above the accommodating bin, a pushing rod and a piston thereof airtightly fitted to the syringe barrel are installed inside the syringe barrel, the piston is installed below the pushing rod for manually operating pressure extraction along the syringe barrel, a pressure valve is installed between the syringe barrel and the accommodating bin for increasing the pressure in the syringe barrel, at least one check valve is installed on a bottom of the accommodating bin for controlling extraction concentration of coffee or tea, and the check valve includes corresponding mounting holes on a mounting plate on a bottom of the accommodating bin; a base tube installed in each mounting hole; a silicone cap assembled on the lower side of the base tube; and a cut formed on the silicone cap.

2. The syringe-type manual pressure brewing device according to claim 1, wherein a control panel is further installed on the outside of the mounting plate, an opening corresponding to the position of the check valve is formed on the control panel, and the control panel is rotated to adjust corresponding degree of openness between the opening and the check valve.

3. The syringe-type manual pressure brewing device according to claim 2, wherein the pressure valve is made of a silicone orifice plate having a plurality of silicone holes, and a cut which is able to close naturally is formed on each silicone hole.

4. The syringe-type manual pressure brewing device according to claim 3, wherein the cut is a cross cut, a straight line cut or a double cross cut, the cut is formed on a protruded portion inside the silicone hole, and the protruded portion is installed to face the accommodating bin.

5. The syringe-type manual pressure brewing device according to claim 4, wherein a top of the pushing rod has a pushing rod head for conveniently pressing.

6. The syringe-type manual pressure brewing device according to claim 5, wherein a container cup is mounted below the control panel, and a blocking portion which is extensionally installed around the outer edge of the accommodating bin is used to fittingly position the container cup.

7. The syringe-type manual pressure brewing device according to claim 6, wherein the bottom of the accommodating bin further has a metal filter for blocking the coffee powder.

8. The syringe-type manual pressure brewing device according to claim 7, wherein a sealing ring is installed around the outer edge of the piston for hermetically contacting an inner wall of the syringe barrel.
